(19) United States
(12) Patent Application Publication
(10) Pub. No.: US 2008/0107294 A1
(43) Pub. Date: May 8, 2008

(54) Programmable Hearing Health Aid Within A Headphone Apparatus, Method Of Use, And System For Programming Same

(75) Inventors: Mark Burrows, Princeton, NJ (US); John Cronin, Jericho, VT (US); Tushar Narsana, Naperville, IL (US); John Anthony Singarayar, Skillman, NJ (US)

Correspondence Address: MCCARTER & ENGLISH, LLP, FOUR GATEWAY CENTER, 100 MULBERRY STREET, NEWARK, NJ, 07102, US

(73) Assignee: JOHNSON & JOHNSON CONSUMER COMPANIES, INC., Skillman, NJ (US)

(21) Appl. No.: 11/570,490

(22) PCT Filed: Jun. 14, 2005
(86) PCT No.: PCT/US05/20999

§ 371 Date: Oct. 2, 2007

Related U.S. Application Data
(60) Provisional application No. 60/579,803, filed on Jun. 15, 2004.

(51) Int. Cl. H04R 25/02; H04R 29/00

(52) U.S. Cl. 381/312; 381/314; 381/60

(57) ABSTRACT

A programmable hearing aid (100) combined with a headphone apparatus. The headphone apparatus may be directly interfaced with various types of electronic equipment so that the user is able to listen to music recordings, voice recordings, or other types of sound signals that are then corrected, via programming, for the user's particular hearing needs (104). A method of using the hearing aid combined with the headphones, including the associated programming system (102) for making corrections for the particular hearing needs are also provided.

### CROSS REFERENCE TO RELATED APPLICATION

This application claims the benefit of U.S. Provisional Application No. 60/579,803 filed Jun. 15, 2004, assigned to the assignee of this application and incorporated by reference herein.

### FIELD OF THE INVENTION

The present invention relates to a programmable hearing health aid within a headphone apparatus, as well as to the method of using and the system for programming the aid. More particularly, the present invention provides a programmable hearing health aid within a consumer-based headphone apparatus with an added programmable digital signal processor, controller, and amplifier, as well as a means to program the hearing health aid headphone according to user-specific hearing data.

### BACKGROUND OF THE INVENTION

About two million hearing aids are sold annually in the U.S., generating $2.6 billion in revenue. Although twenty-eight million Americans are hearing impaired, only six million of them use hearing aids. Year after year, market penetration has increased little, making it apparent that factors other than patient need have inhibited market penetration. Central among these factors is the product-centric (as opposed to patient-centric) approach that the hearing aid industry has taken to fitting hearing aids. Hearing aid manufacturers concentrate marketing efforts almost solely on improving their devices, most notably with digital signal processors (DSPs), while other user needs and preferences are limited or virtually ignored.

One instance in which conventional hearing aids are limited in their usefulness is when hearing aid users wish to listen to music or voice recordings on consumer electronic equipment (e.g., televisions, and stereos). Hearing aid users often must adjust the volume settings on this electronic equipment to suit the operation of their hearing aid(s). Unfortunately, an adequate volume for the hearing aid user may be uncomfortably loud (or inaudibly quiet) for other listeners in the room, reducing the ability of all to enjoy the benefits of electronic listening and diminishing the privacy of the hearing aid user.

An apparent solution to this problem is for the hearing aid user to wear headphones that interface directly with the consumer electronic device. However, it is sometimes impossible for hearing aid users to wear conventional headphones because of the headphones are physically incompatible with hearing aids. Another drawback to conventional headphones is that they may cause electronic feedback noise in hearing aids, severely limiting the ability of the hearing aid user to enjoy the consumer electronic device. A further drawback is that the headphones are not optimized to the individual's hearing loss or needs,

The discomfort hearing aid users may experience with conventional hearing aids is another factor limiting more widespread use of hearing aids. Because hearing aids must typically be worn for long periods of time during the day, ear irritation can discourage a user from wearing the hearing aid at home or in a relaxed setting, limiting the users' ability to enjoy a full range of hearing at all times. A more comfortable alternative to the hearing aid for listening to ambient sound, an alternative that is designed to interface with consumer electronic devices of different types for direct listening to music or television, is needed. Further, if hearing aids are designed to interface with consumer electronic devices, a combined marketing effort between the consumer electronic device industry and the hearing health industry has a potential to convince millions of previously unreachable hearing-impaired individuals to take advantage of hearing correction products.

U.S. Pat. No. 6,201,875, incorporated by reference herein, describes a method of fitting a hearing compensation device that includes selecting a plurality of loudness levels for a plurality of frequency ranges and comparing each loudness level for each frequency for perceived sameness. The loudness levels may then be adjusted as needed to achieve perceived sameness across the frequency spectrum. A gain curve for each frequency is calculated from the selected plurality of loudness levels. With hearing aid in ear, users sit at a computer or similar graphical user interface and respond to loudness of tones in each of twelve frequency ranges. The hearing aid itself emits these test tones in one frequency range at a time; users adjust the volume to their individual preference. This process is repeated for all twelve frequency ranges; results are sent with the hearing aid to its manufacturer for programming. The programmed hearing aid is shipped back to the audiologist.

The '875 patent demonstrates hearing aid devices capable of being programmed and customized at professionals' offices. Conceptually, such programming is the audiologist's version of the optometrist's standard eyeglass-fitting procedure, i.e., asking users as to the clarity of eye charts, adjusting focal correction, and then repeating these steps until the focal correction is optimized. The optimal correction, called a prescription, is then applied to corrective lenses for that individual user. Although this fitting has improved user satisfaction with hearing aids, it still falls short of addressing the other above-mentioned critical user needs of privacy, compatibility with consumer electronic devices, and comfort.

### SUMMARY OF THE INVENTION

It is therefore an object of the present invention to provide hearing aid users increased levels of privacy.

It is another object of the present invention to provide a hearing aid that enables hearing aid users to enjoy consumer electronic devices.

It is yet another object of the present invention to provide hearing aid users increased levels of comfort.

It is yet another object of the present invention to provide a hearing aid user with a device that is programmable and customized to the user, as well as that incorporates the above-mentioned objects of privacy, compatibility with consumer electronic devices, and comfort.

It is yet another object of the present invention to provide a business process in which a hearing aid manufacturer partners with the manufacturer of a consumer electronic device such as a headphone apparatus.

Accordingly, the present invention provides a programmable hearing health aid integrated into a comfortable headphone apparatus, and a means to program the hearing health aid with user-specific hearing correction data. The hearing health aid integrated with the headphone apparatus is designed to be comfortable for the user, to be simple to operate, and to increase privacy for the user. Further, the headphone apparatus may be directly interfaced with various types of electronic equipment so the user is able to listen to music recordings, voice recordings, or other types of sound signals that are then corrected for the user's particular hearing needs. A method of using the hearing health aid, the associated programming system, and a business process in which the hearing health aid manufacturer partners with a separate manufacturer of headphone apparatuses are also presented.

Thus, the present invention provides a programmable hearing health aid for integrating into a headphone apparatus, the health aid comprising:
an interface for coupling to an external data signal communications means and for receiving hearing aid programming data; and
a digital signal processor (“DSP”) coupled to the external communications means and a hearing aid speaker interface and to at least one of an external device interface (e.g. stereo output) and a hearing aid microphone interface, wherein the DSP includes a memory for storing DSP correction factors corresponding to a user hearing profile included in the programming data received at the external communications interface, wherein the DSP uses the DSP correction factors to generate DSP correction factor audio output signals from at least one of audio signals received at the microphone interface and electronic sound signals received at the external device interface, wherein the DSP transmits the DSP correction factor audio output signals to the speaker interface.

Thus, the present invention further provide for a hearing aid headphone apparatus comprising:

first and second ear headphones coupled to first and second programmable hearing health aids, respectively, wherein each of the first and second programmable hearing health aids is constructed as described above and wherein the memory includes first and second sets of DSP correction factors.

### BRIEF DESCRIPTION OF THE DRAWINGS

Other objects and advantages of the present invention will be apparent from the following detailed description of the presently preferred embodiments, which description should be considered in conjunction with the accompanying drawings in which like references indicate similar elements and in which:

FIG. 1 is a high-level system diagram of a programming system for a hearing health aid.

FIG. 2 illustrates a headphone apparatus with an integrated hearing health aid.

FIG. 3 represents a detailed functional block diagram of the hearing health aid apparatus.

FIG. 4 is a method of using the programmable hearing health aid and headphone apparatus.

FIG. 5 is a method of executing a business process between the manufacturer of the headphone apparatus and the manufacturer of the hearing health aid.

### DESCRIPTION OF THE INVENTION

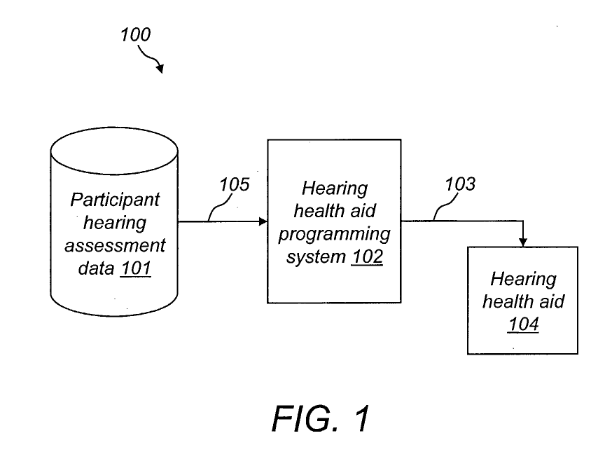

FIG. 1 is a high-level diagram of a system 100, including a plurality of participant hearing assessment data 101, a hearing health aid programming system 102, a programming interface 103, a hearing health aid 104, and a data storage interface 105.

Participant hearing assessment data 101 is data collected from a person who has participated in a hearing test. A professional audiologist may have administered the hearing test, or it may have been self-administered using an at-home hearing test. Participant hearing assessment data 101 is stored in digital form within a data storage device such as a hard disk drive, and represents user demographic information as well as the user's hearing loss profile with associated correction factors.

Hearing health aid programming system 102 is a computer system capable of executing software programs. Hearing health aid programming system 102 is capable of accessing participant hearing assessment data 101 through data storage interface 105. In one embodiment, hearing health aid programming system 102 is a general-purpose computer. In another embodiment, hearing health aid programming system 102 is a computer system designed for the specific purpose of hearing health aid programming.

Hearing health aid programming system 102 is capable of accessing participant hearing assessment data 101 through data storage interface 105. Data storage interface 105 is any data communication path that may be used to transfer data to and from the data storage device containing participant hearing assessment data 101. Examples include SCSI, IDE bus, Fiber Channel, and Firewire, among others. Hearing health aid programming system 102 is further connected to hearing health aid 104 via programming interface 103. Programming interface 103 is a data communications pathway providing a way for hearing health aid programming system 102 to program the functionality of hearing health aid 104. In one embodiment, programming interface 103 is a standard serial bus such as I²C bus, RS232, or other.

Hearing health aid 104 is a programmable hearing health aid designed for integrating into a comfortable headphone apparatus.

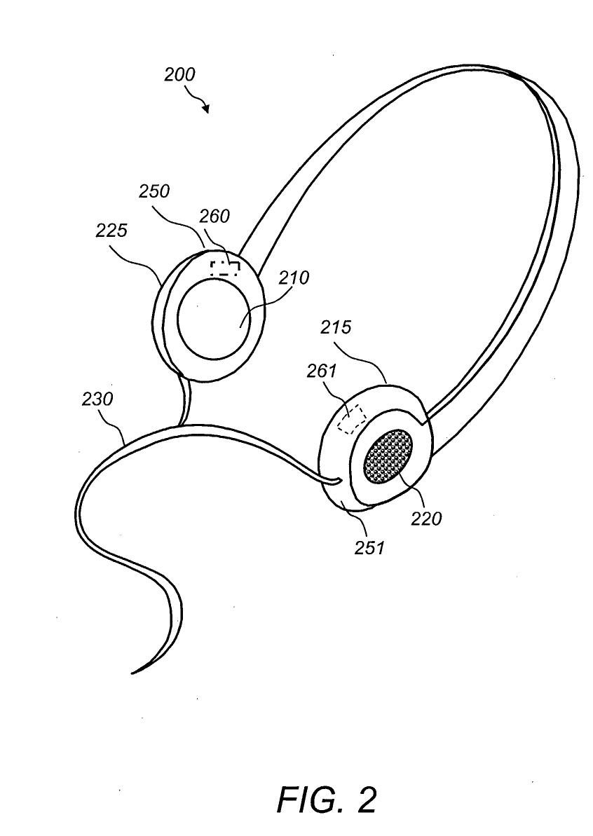

FIG. 2 illustrates a headphone apparatus 200, which includes a right ear headphone 250 that further includes a right ear microphone 225, a right ear speaker 210, and an integrated right hearing health aid 260. Headphone apparatus 200 also includes a left ear headphone 251 that further includes a left ear microphone 220, a left ear speaker 215, and an integrated left hearing health aid 261. Headphone apparatus 200 further includes a length of interface wiring 230.

Right hearing health aid 260 and left hearing health aid 261 are representative of hearing health aid 104 of FIG. 1, and are embedded within right ear headphone 250 and left ear headphone 251, respectively. Right hearing health aid 260 and left hearing health aid 261 are programmed to the individual's hearing loss needs. Interface wiring 230 connects electrically to a connection point on right hearing health aid 260 and a connection point on left hearing health aid 261, and includes both the programming interface connections as well as external device input connections (not shown). Interface wiring 230 can be disconnected easily from headphone apparatus 200.

In a preferred embodiment, a wireless signal interface, including conventional wireless signal processing equipment, is incorporated into each of the aids 260 and 261, such that interface wiring 230 is not required.

In operation, the user wears headphone apparatus 200 while listening to ambient sound (e.g., spoken voices, music) surrounding the user. Ambient sound enters headphone apparatus 200 as an audio signal via right ear microphone 225 and/or left ear microphone 220 or via electrical signals carried on interface wiring 230 (operation of which is described later). Whether the audio signals are introduced by right ear microphone 225, left ear microphone 220, or electrical signals carried on interface wiring 230, the signals are processed by right hearing health aid 260 and left hearing health aid 261, as appropriate. The outputs of right hearing health aid 260 and left hearing health aid 261 are connected to right ear speaker 210 and left ear speaker 215, respectively. Right hearing health aid 260 and left hearing health aid 261 are programmed through interface wiring 230. Hearing health aid 104 conditions the audio signal to the user's specific hearing profile, as programmed by hearing health aid programming system 102. Hearing health aid 104 then transmits the conditioned audio signal to right ear speaker 210 and left ear speaker 215 through which the user hears the conditioned audio signal.

It is well known that headphones provide users with increased privacy and comfort, and are easily compatible with consumer electronic devices. Therefore, headphone apparatus 200 demonstrates a hearing aid device that is customized to the user and that provides users with increased levels of privacy, compatibility with consumer electronic devices, and comfort.

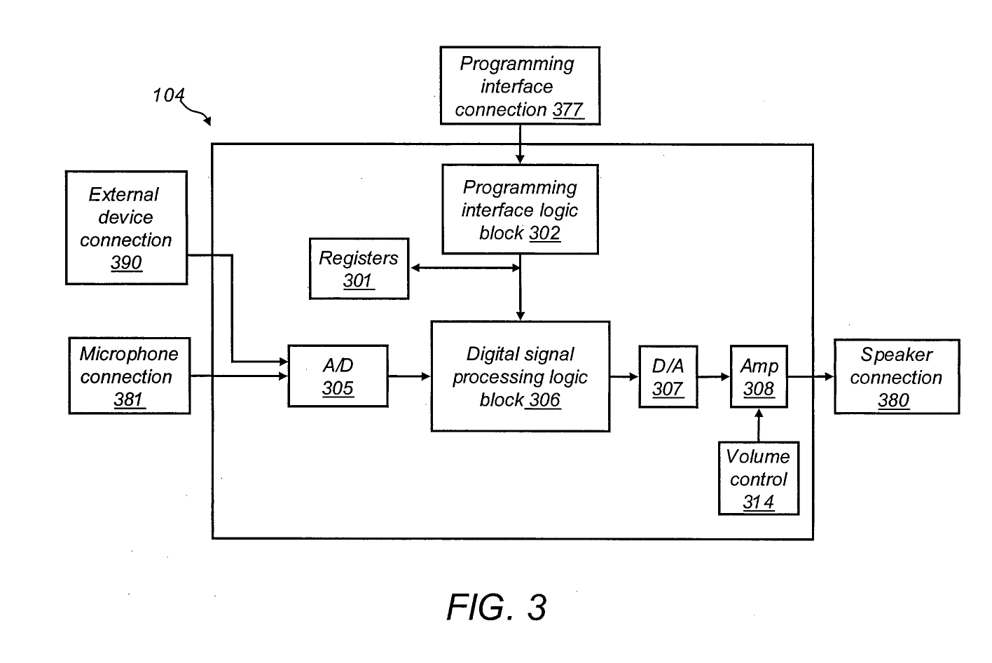

FIG. 3 is a detailed functional block diagram of hearing health aid 104 of FIG. 1, which is also representative of right hearing health aid 260 and left hearing health aid 261. Hearing health aid 104 further includes a plurality of registers 301, a programming interface logic block 302, an analog/digital converter (A/D) 305, a digital signal processing logic block 306, a digital/analog converter (D/A) 307, an amplifier (amp) 308, an external device connection 390, a microphone connection 381, a speaker connection 380, a programming interface connection 377, and a volume control 314.

External device connection 390 may be any of a group of consumer-related device audio outputs, such as outputs from a compact disc player, radio, television, etc. External device connection 390 is a two-wire connection using standard connectors.

The functional blocks of hearing health aid 104 are connected as shown in FIG. 3. Programming interface logic block 302 communicates with hearing health aid programming system 102 of FIG. 1 via programming interface connection 377 (analogous to interface wiring 230 of FIG. 2), providing proper signal levels and bus protocol. Through programming interface logic block 302, hearing health aid programming system 102 is provided access to registers 301 and internal memory locations within digital signal processing logic block 306. Registers 301 are programmable control and status registers with connections (not shown) to various functional blocks of hearing health aid 104. Digital signal processing logic block 306 contains the necessary digital logic to store and execute signal processing software algorithms. Included (but not shown) in digital signal processing logic block 306 is a digital signal processor and non-volatile memory. Other embodiments may include volatile memory and other support logic.

A/D 305 converts analog signals generated by left ear microphone 220 through microphone connection 381, right ear microphone 225 through microphone connection 381, or external device connection 390 into digital data for input to digital signal processing logic block 306. D/A 307 is dual channel digital-to-analog converter and converts right and left channel digital output data generated by digital signal processing logic block 306 into analog signals to be output to amp 308. Amp 308 is a stereo audio amplifier that provides output signal levels to speaker connection 380, which is suitable for right ear speaker 210 and left ear speaker 215 of FIG. 2. The amplitude gain of amp 308 is variable and can be controlled by the user via volume control 314.

Programmable hearing aids with digital processing elements are well known in the conventional art. These conventional devices must be miniaturized to the point of fitting in or on the wearer's ear. However, hearing health aid 104 is intended to be integrated into headphone apparatus 200 or an earphone assembly. In one embodiment of hearing health aid 104, the various functional blocks are implemented with off-the-shelf components mounted on and electrically connected through printed circuit board material. In another embodiment, the functional blocks are integrated into one or more application-specific integrated circuits.

In operation, hearing health aid 104 of FIG. 1 is first programmed with digital signal processing algorithms and control register information. The digital signal processing algorithms are produced by hearing health aid programming system 102 of FIG. 1 using participant hearing assessment data 101, and therefore are specific to the hearing profile of the participant. This provides hearing health aid 104 with the means to alter the frequency/amplitude characteristics of the incoming audio signal received by left ear microphone 220, right ear microphone 225, or external device connection 390 to produce an output audio signal with increased signal amplitude for those frequency ranges at which the participant's hearing sensitivity has been compromised. The digital signal processing algorithms are then downloaded to non-volatile memory within digital signal processing logic block 306 via programming interface connection 377.

Headphone apparatus 200 in combination with the above detailed functional block diagram demonstrates a hearing aid device that is programmable and that incorporates the above-mentioned objects of privacy, compatibility with consumer electronic devices, and comfort.

In a separate embodiment, the user connects interface wiring 230 to separate electronic equipment (e.g., a stereo or television) and wears headphone apparatus 200. Hearing health aid 104 conditions the audio signal entering headphone apparatus 200 via interface wiring 230 to the user's specific hearing profile, as programmed by hearing health aid programming system 102. Hearing health aid 104 then transmits the conditioned audio signal to right ear speaker 210 and left ear speaker 215, where the user hears the conditioned audio signal. The signal may be music or voice recordings, a television sound signal, or other type of electronic sound signal.

In yet another embodiment, headphone apparatus 200 may take the form of commercially available miniaturized earpieces (commonly known as “earbuds”) that are placed within the ears and are connected by a common interface wiring 230.

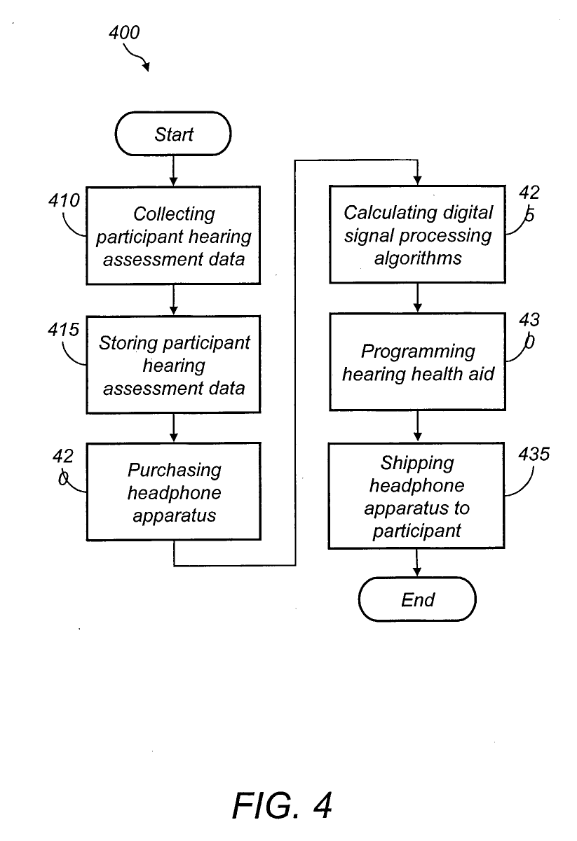

FIG. 4 illustrates a method 400 of using system 100 and headphone apparatus 200. The steps include:

Step 410: Collecting Participant Hearing Assessment Data

In this step, using any of several means of hearing testing, from Web-based testing facilities to complete a professional audiologist test, the participant interacts with the testing program to determine the extent and nature of the participant's hearing. Participant hearing assessment data 101 is then generated based on the participant's responses and is stored to be accessible later for programming personalized headphone apparatus 200. An example of such a Web-based testing facility is described in “A System For and Method of Conveniently and Automatically Testing the Hearing of a Person”, U.S. Provisional Application No. ______, filed Jun. 15, 2004, assigned to the assignee of this application and incorporated by reference herein.

Step 415: Storing Participant Hearing Assessment Data

In this step, participant hearing assessment data 101 collected in step 410 is stored in a storage device accessible to hearing health aid programming system 102.

Step 420: Purchasing Headphone Apparatus

In this step, the participant purchases headphone apparatus 200 from a hearing health provider or any of a number of on-line or physical retail locations.

Step 425: Calculating Digital Signal Processing Algorithms

In this step, using participant hearing assessment data 101 collected and stored in the previous steps, hearing health aid programming system 102 calculates the appropriate digital signal processing algorithms to produce audio output to address the specific hearing profile of the participant.

Step 430: Programming Hearing Health Aid

In this step, hearing health aid programming system 102 downloads digital signal processing algorithms to non-volatile memory within digital signal processing logic block 306 via programming interface connection 377.

Step 435: Shipping Headphone Apparatus to Participant

In this step, the programmed and tested hearing health aid 104 is integrated into headphone apparatus 200 and shipped to the participant for evaluation. Method 400 ends.

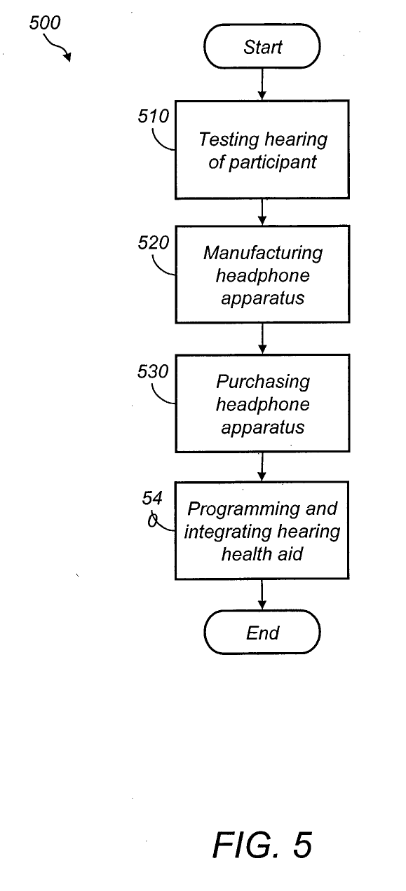

FIG. 5 illustrates a method 500 of executing a business process between the manufacturer of headphone apparatus 200 and the manufacturer of hearing health aid 104. The steps include:

Step 510: Testing Hearing of Participant

In this step, a participant undergoes a hearing test conducted by a first-party establishment, such as an audiologist, a hearing health center, or a Web-based program. The test data is stored and is accessible to the individual via access through the first-party establishment.

Step 520: Manufacturing headphone apparatus

In this step, a second-party establishment, such as an established manufacturer of electronic equipment, manufacturers a volume of programmable headphone apparatuses 200 capable of interfacing with hearing health aid 104 according to a pre-established relationship.

Step 530: Purchasing Headphone Apparatus In this step, the participant purchases headphone apparatus 200 from a third-party establishment, such as a retail hearing aid dealer.

Step 540: Programming and Integrating Hearing Health Aid

In this step, a first-party establishment, such as a hearing health center or audiologist, accesses the participant's hearing data and programs hearing health aid 104 according to the participant's hearing profile, as described in method 400. The first-party establishment also integrates hearing health aid 104 into headphone apparatus 200. Alternatively, the first party establishment may provide the participant's hearing data to the second- or third-party establishments. The second- or third-party establishments may then perform programming of hearing health aid 104 and integration of hearing health aid 104 into headphone apparatus 200.

Although preferred embodiments of the present invention have been described and illustrated, it will be apparent to those skilled in the art that various modifications may be made without departing from the principles of the invention.

What is claimed is:

1. A programmable hearing aid combined with a headphone apparatus, the hearing health aid comprising:
an interface for coupling to an external data signal communications means and for receiving hearing aid programming data; and
a digital signal processor (DSP) coupled to the external communications means and a hearing aid speaker interface.

2. The hearing aid of claim 1, wherein the DSP is further coupled to at least one of an external device interface.

3. The hearing aid of claim 2, wherein the at least one of the external device interface is a stereo output.

4. The hearing aid of claim 2, wherein the DSP is further coupled to a hearing aid microphone interface.

5. The hearing aid of claim 4, wherein the DSP includes a memory for storing DSP correction factors corresponding to a user hearing profile included in the programming data received at the external communications interface.

6. The hearing aid of claim 5, wherein the DSP uses the DSP correction factors to generate DSP correction factor audio output signals.

7. The hearing aid of claim 6, wherein the correction factors audio output signals are generated from at least one of audio signals received at the microphone interface and electronic sound signals received at the external device interface.

8. The hearing aid of claim 6, wherein the DSP transmits the DSP correction factor audio output signals to the speaker interface.

9. The hearing aid combined with a headphone apparatus of claim 1, wherein the hearing health aid and the headphone apparatus form an integral part.

10. The hearing aid of claim 1, wherein the headphone interfaces with an external electronic apparatus.

11. The hearing aid of claim 10, wherein the external electronic apparatus comprising a device that stores music.

12. The hearing aid of claim 10, wherein the external electronic apparatus comprising a device that stores voice recordings.

13. The hearing aid of claim 10, wherein the external electronic apparatus comprising a device that stores sound signals.

14. A hearing aid headphone apparatus comprising:
a headphone coupled to a programmable hearing aid, wherein the programmable hearing health aid is integrated into a headphone apparatus, including
an interface for coupling to an external data signal communications means and for receiving hearing aid programming data; and
a digital signal processor (DSP) coupled to the external communications means and a hearing aid speaker interface and wherein the memory includes first and second sets of DSP correction factors.

15. A hearing health aid headphone apparatus comprising:
a first and a second ear headphone coupled to first and second programmable hearing health aids, respectively, wherein each of the first and second programmable hearing health aids is a programmable hearing health aid integrated into a headphone apparatus, including
an interface for coupling to an external data signal communications means and for receiving hearing aid programming data; and
a digital signal processor (DSP) coupled to the external communications means and a hearing aid speaker interface and wherein the memory includes first and second sets of DSP correction factors.

16. A method for using a hearing health aid headphone apparatus comprising the steps of:
providing a headphone coupled to a programmable hearing health aid, wherein the programmable hearing health aid is integrated into a headphone apparatus, including
providing an interface for coupling to an external data signal communications means and for receiving hearing aid programming data; and
providing a digital signal processor (DSP) coupled to the external communications means and a hearing aid speaker interface and wherein the memory includes first and second sets of DSP correction factors.

17. A method for using a hearing aid headphone apparatus comprising the steps of:
providing a first and a second ear headphone coupled to first and second programmable hearing aids, respectively,
providing an interface for coupling to an external data signal communications means and for receiving hearing aid programming data; and
providing a digital signal processor (DSP) coupled to the external communications means and a hearing aid speaker interface, wherein the programming data include DSP correction factors.

18. A method of using a hearing aid headphone apparatus comprising the steps of:
providing a headphone;
providing a programmable hearing aid;
connecting the headphone and the programmable hearing aid;
providing an interface for coupling to an external data signal communications means for receiving hearing aid programming data;
coupling a digital signal processor (DSP) to the external data signal communications means to a hearing aid speaker interface;
providing a first and a second set of DSP correction factors;
interfacing the headphone directly with an electronic equipment providing audible signals.
